(19) United States
(12) Patent Application Publication
(10) Pub. No.: US 2002/0029184 A1
(43) Pub. Date: Mar. 7, 2002

(54) Method and system for network wine auctioning

(76) Inventor: Gary Reiner, Potomac, MD (US)

Correspondence Address: Supervisor, Patent Prosecution Services, PIPER MARBURY RUDNICK & WOLFE LLP, 1200 Nineteenth Street, N.W., Washington, DC, 20036-2412, US

(21) Appl. No.: 09/859,533

(22) Filed: May 18, 2001

Related U.S. Application Data
(60) Provisional application No. 60/205,235, filed on May 19, 2000.

(51) Int. Cl. G06F 17/60

(52) U.S. Cl. 705/37; 705/26

(57) ABSTRACT

A method and system for auctioning wines or other alcoholic beverages via a network, such as the Internet, with or without the purchased goods crossing state lines and without violating state laws. Local retailers' wine is consigned (transferred or non-transferred), advertised, or otherwise represented by a licensed wine auction company, and optionally shipped to the auction company's state. The wine is auctioned via a server optionally located in the auction company's state. Buyers purchase the goods via the server and the network and retrieve the goods from the local retailer. Taxes are paid by either the local retailer or the auction company. The local retailer thus effectively auctions wine without an auctioneers license, and with or without the goods crossing state lines. With this method and system, retailers can be located in every state, and purchasers in all states can buy alcoholic beverages at auction.

This application claims priority from U.S. Provisional Application Ser. No. 60/205,235 filed May 19, 2000. The entirety of that provisional application is incorporated herein by reference.

### BACKGROUND OF THE INVENTION

1. Field of the Invention

This invention relates to methods and systems for auctioning wines or other alcoholic beverages on a network, and in particular, to methods and systems for auctioning wines on a network, such as the Internet, such that the auction is conductible within and/or across state lines without violating state alcoholic beverage laws.

2. Background of the Technology

Due to the myriad of alcoholic beverage regulations imposed by each state regarding the sale and/or auctioning of alcoholic beverages, including the sale and/or auctioning of alcoholic beverages over the Internet, retail and auction licensing requirements, and the transport of alcoholic beverages into and out of states, the “method and system for network wine auctioning” necessitates optional methodology so as to conform to the requirements of the laws of each state. The method and system for network wine auctioning is therefore unique and the outcome of in-depth research and analysis so as to determine a viable process adaptive to the inherent differences of alcoholic beverage laws that vary from state to state.

### SUMMARY OF THE INVENTION

The present invention includes a method and system for auctioning wines or other alcoholic beverages via a network, such as the Internet, without the purchased wine or alcoholic beverage crossing state lines or otherwise violating state alcoholic beverage laws. Local retailers' wines or alcoholic beverages are consigned (transferred or non-transferred) and either not shipped or optionally shipped to a warehouse for an auction company located in a host state, such as Delaware. A server for the auction company also located in the host state then auctions the wines or alcoholic beverages via the network. A second or alternative server located in the state in which the retail store is located may also be used to independently or co-jointly auction the wines or alcoholic beverages via the network. Buyers purchase the wines or alcoholic beverages via the network using a terminal, such as a personal computer, and then the buyers retrieve the purchased wine or alcoholic beverage from the local retailer. The local retailer thus effectively auctions the wine or alcoholic beverage without having to have an auctioneer's license, without the wine or alcoholic beverage crossing state lines, and without state alcoholic beverage laws being violated.

Payment for the wines are collected by either the local retailer or the auction company acting as a state licensed “Agent” for the retailer or alternatively, as a licensed wine auctioneer or both. State alcoholic beverage taxes are also collected during the payment process and paid by the retailer to the state treasury. Retailers associated with the auction process are includable for all states, so that purchasers in any state are able to buy at auction wines and alcoholic beverages located in their home state.

In order for the retailer to avoid violating state regulations prohibiting the auctioning of wines by an unlicensed (wine auction) retailer, the host auction site in possession of a wine auction license auctions the retailer's wines. Alternatively, in order for the host auction company to avoid violating state regulations prohibiting the host auction site from acting as an unlicensed (retail seller of alcoholic beverages) retailer, the host auction site acts as a state authorized (licensed or non-licensed) Agent for the retailer.

Further, in order for the retailer to avoid violating state regulations prohibiting the auctioning of goods by an unlicensed (wine auction) retailer, the payment transactions (invoices) for wines purchased at auction are processed in the name (sold by) of the host auction company. Alternatively, in order for the host auction company to avoid violating state regulations prohibiting the host auction site from acting as an unlicensed (retail seller of alcoholic beverages) retailer, the payment transactions (invoices) for wines purchased at auction are processed in the name (sold by) of the retailer.

Further, in order for the point of sale transaction to be recorded by the auction company as taking place in the state of the host auction company, the server is located in the same state as the host auction company. Alternatively, in order for the point of sale transaction to be recorded as occurring in the state of the local retailer, a server is located in the same state as the local retailer.

To achieve the stated and other advantages of the present invention, as embodied and described below, the invention includes a method for auctioning, to a purchaser, wines from a local retailer using a host auction company via a network, the method comprising: the local retailer consigning the wines to the host auction company; the host auction company auctioning the wines; the purchaser purchasing the wines; and the purchaser obtaining the purchased wines directly from the local retailer.

To achieve the stated and other advantages of the present invention, as embodied and described below, the invention further includes a method for auctioning, to a purchaser, wines from a local retailer using a host auction company via a network, the method comprising: the local retailer consigning the wines to the host auction company; the host auction company auctioning the wines; the purchaser purchasing the wines; and the purchaser obtaining the purchased wines from the host auction company acting on behalf of the local retailer.

To achieve the stated and other advantages of the present invention, as embodied and described below, the invention further includes a method for auctioning, to a purchaser, wines from a local retailer using a host auction company via a network, the method comprising: the local retailer consigning the wines to the host auction company; the host auction company auctioning the wines; and the purchaser purchasing wines from the local retailer in conjunction with the host auction company acting as licensed agent of the local retailer.

To achieve the stated and other advantages of the present invention, as embodied and described below, the invention further includes a method for auctioning, to a purchaser, wines from a local retailer using a host auction company via a network, the method comprising: the local retailer consigning the wines to the host auction company; the host auction company auctioning the wines; the purchaser purchasing wines from the licensed wine auction retailer in conjunction with the host auctioneer acting as licensed agent of the local retailer; the host auction company using a third party online company to display wines in auction format; and the third party online company to act as an auction medium of the host auction company.

To achieve the stated and other advantages of the present invention, as embodied and described below, the invention further includes a system for auctioning, to a purchaser, wines from a local retailer using a host auction company via a network, comprising: at least one terminal coupled to the network; and a server for the host auction company coupled to the network; wherein the local retailer consigns the wines to the host auction company; wherein the host auction company auctions the wines via the at least one server and via the network; wherein the purchaser purchases the wines via the at least one terminal via the network; and wherein the purchaser obtains the purchased wines from the local retailer.

Additional advantages and novel features of the invention set forth in part in the description that follows, considered in conjunction with the accompanying drawing figures, will become more apparent to those skilled in the art upon examination of the following or upon learning by practice of the invention. It is to be understood, however, that the drawings are designed solely for the purposes of illustration and not as a definition of the limits of the invention.

### BRIEF DESCRIPTION OF THE FIGURES

In the drawings:

FIG. 1 depicts an overview of the components of an embodiment of the present invention;

FIG. 2, illustrating the legal process, in accordance with embodiments of the present invention, demonstrates how retailers in an example state, such as Maryland, are able to use the RAN to comply with state law;

FIG. 3 illustrates benefits to network retailers of various embodiments of the present invention;

FIG. 4 shows how the host transforms RAN into a viable, e-commerce retail chain, in accordance with an embodiment of the present invention; and

FIGS. 5-13 present sample graphical user interface (GUI) screens for a network-based system for use in accordance with an embodiment of the present invention.

### DETAILED DESCRIPTION

The present invention includes a wine auction model that is usable either alone or in conjunction with existing Internet or other network auction service provider functions. The model actually contains three interrelated strategies: 1) RAN (Retailer's Auction Network); 2) Collector's Online Auction; and 3) Live Auction. The main component of the model and primary element of the invention is the RAN. RAN is an e-commerce or online wine auction network that is directly affiliated with retailers and predominantly targeting the local consumer market in the state in which the retailer is licensed.

The Collector's Online Auction is a traditional online auction that targets individual buyers and sellers.

The Live Auction is also traditional in structure and purpose. This revolutionary business to business, wine auction model incorporates a germane strategy for the legal interstate shipment of wine.

RAN is a unique concept that contains a methodology that conforms to the alcoholic beverage regulations of each state regarding the auctioning of wine over a network. This methodology does not elsewhere exist.

In order to implement the RAN, a formal liaison is put in place with hundreds of retailers licensed in all states of the country. Retailers who join the network become a “Partner” of RAN. The formal networking process involves a “cooperative auction agreement,” granted by the host service provider (auctioneer) to qualified retail sites residing in eligible states, as further described below.

In exchange for the signing of the agreement, the retailers' consigned wines are hosted on, for example, an Internet “portal.” Each retailer belonging to the Network is assigned their own space within the portal, defined as a “Key Word” area. Consigned (transferred or non-transferred) or advertised or otherwise represented wines are then hosted in the retailer's specified universal resource locator (URL)/Key Name auction area.

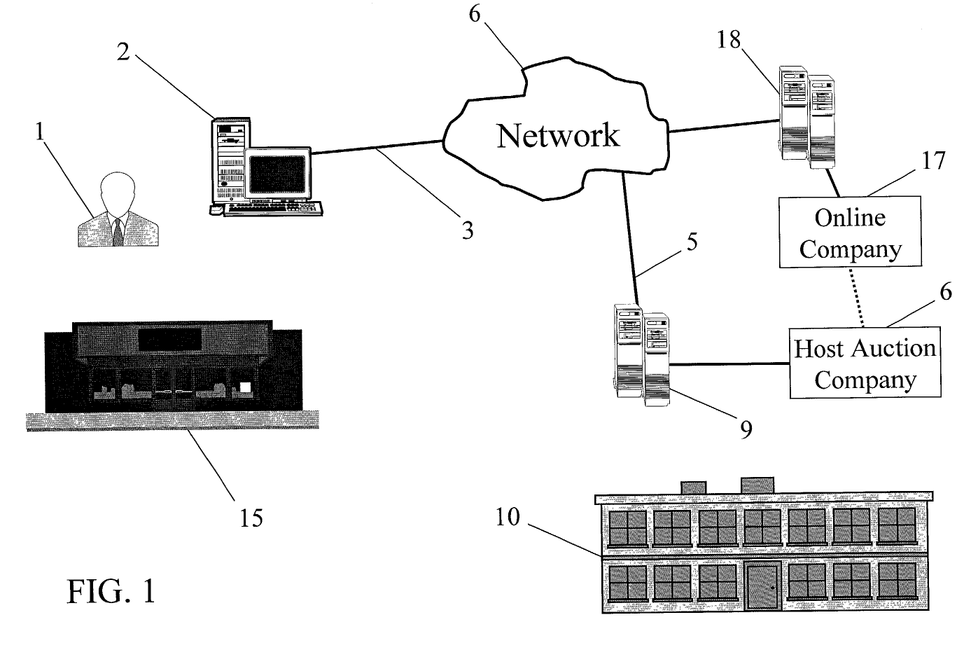

FIG. 1 depicts an overview of the components of an embodiment of the present invention. As shown in FIG. 1, a user 1, such as a purchaser, at a terminal 2, such as a personal computer, minicomputer, microcomputer, mainframe computer, interactively connected television, telephone device, or other device for interactively obtaining information, the device including, for example, a display and capability for providing browsing on a network, including a graphical user interface (GUI), communicates via couplings 3, 5 and a network 6, such as the Internet or an intranet, with a server 9, such as a personal computer, minicomputer, microcomputer, mainframe computer, or other device having a processor and, optionally, a repository or coupling to a repository for storing and accessing information. The couplings 3, 5 may include, for example, wired, wireless, or fiberoptic communication links. Associated with the server 9 is an auctioneer, such as a host auction company 16. Wines or other alcoholic beverages are available via a local retailer 15 and/or the host auction company 16. Associated with the server 9 may be another auctioneer, such as a retailer 15 with a wine or alcoholic beverage auction license issued by the state in which the retailer is licensed. Optionally associated with 9 is a warehouse 10 for storing wines or other alcoholic beverages. In an embodiment of the present invention, an auction Internet site for the local retailer 15 is placed on the server 9. Wines at the local retailer 15 are consigned (transferred or non-transferred) to the host auction company 16. Optionally, the wines are transferred to the warehouse 10 for the host auction company 16. The wines or alcoholic beverages are then auctioned via the server 9 and the network 6. The user 1, such as a purchaser, at the terminal 2 purchases wine or alcoholic beverage via the network 6 and the server 9 through an auction process.

In an embodiment of the present invention, the user 1 then picks up the purchased wine or alcoholic beverage from the local retailer 15. In another embodiment, the user 1 picks up the purchased wine or alcoholic beverage from the warehouse 10 associated with the host auction company 16. In another embodiment, the purchased wine or alcoholic beverage is delivered to user 1 from the warehouse 10 associated with the host auction company 16. In an embodiment of the present invention, the user 1 and the local retailer 15 are located in the same state, so as to avoid interstate shipment of the wine or alcoholic beverage. In an embodiment of the present invention, state taxes for the state where the local retailer 15 is located are collected and paid via the local retailer 15 or collected via the host auction company 16 and then paid by the local retailer 15. In an embodiment of the present invention, the local retailer 15 is paid for the goods directly by the user 1. In an embodiment of the present invention, the host auction company 16 is directly paid by the user 1, and the payment then transferred to the local retailer 15. In an embodiment of the present invention, the host auction company 16 acts as “Agent” for the seller. In an embodiment of the present invention, the host auction company 16 is the auctioneer of the goods.

In an embodiment of the present invention, the local retailer 15 has obtained a license to auction wines issued by the state in which the local retailer 15 is licensed to sell alcoholic beverages. In an embodiment of the present invention, the local retailer 15 with a state issued wine auction license displays its goods for auction on the host auction company's 16 online auction site. In an embodiment of the present invention, the host auction company 16 contracts with one or more online companies 17 to display the auction wines in auction format on the online company's 17 web site 18, thus enabling the auction wines of the local retailer to be presented via multiple online sites. In an embodiment of the present invention, the contracted online company 17 is paid a fee or otherwise contracted with to display the auction wines so as to make them purchasable by visitors to the online company 17. In an embodiment of the present invention, wines displayed for auction by the online company 17 are auctioned by the host auction company 16. In an embodiment of the present invention, payment and other transactions pertaining to the wines displayed for auction on the online company 17 are manually or electronically processed by the host auction company 16.

Embodiments of the present invention include a variety of legal merits. In one embodiment, retailers are provided a legal vehicle to auction wines under their own name within their own state. In the absence of RAN, most retailers are prohibited by state law from holding both an auctioneer's license and retailer's license. Also, most states simply will not grant a state license for the auctioning of wines. In addition, RAN permits its members to consign wines (transfer or non-transfer) for auction to both a national and International audience. This is because RAN members are lawfully allowed (with, for example, an auction license for the host) to direct ship wine to the host state, such as Delaware. The ability to ship wine to the host state is of significant legal and marketing advantage to RAN members who desire to sell their goods outside of their local market.

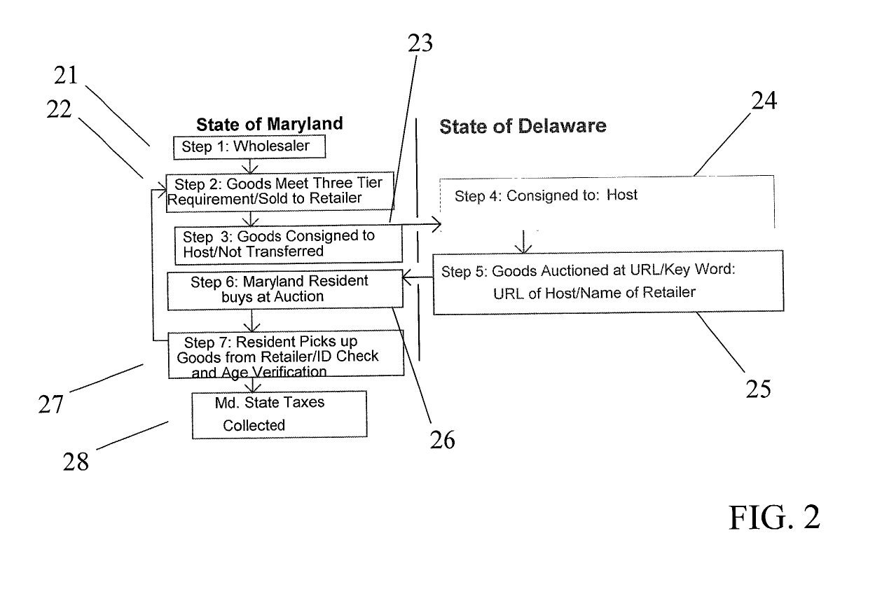

RAN also permits the legal delivery of goods within many jurisdictions and the personal pick-up of goods from the local retailer in all jurisdictions. The reason for this is simple: under the RAN program, wines consigned (non-transferred) by a retailer for auction to a local audience never leave their state of rest. Therefore, laws prohibiting interstate shipment of wine are not violated. In addition, the three tier system or the passing of wines from supplier to wholesaler to retailer remains intact. FIG. 2, illustrating the legal process, in accordance with embodiments of the present invention, demonstrates how retailers in an example state, such as Maryland, are able to use the RAN to comply with state law.

As shown in FIG. 2, the local retailer, a member of RAN, initially obtains goods from the wholesaler 21 and 22. These purchased goods come to rest at the store. As illustrated, these same goods are consigned by the retailer to the system host 23 and 24. However, the consigned goods remain in the state, such as Maryland. The host holds a network auction, such as an Internet auction, respective of the wines consigned by the local retailer 25. The auction is advertised as the local retailer's auction.

The consigned goods are purchased from the Internet auction by a state (e.g., Maryland) resident 26. The state sales tax and cost of the goods is collected by the host. (Another option is that the state sales tax and cost of the goods is collected by the retailer or processed by the host in the name of the retailer). The goods purchased from the host at auction are then picked up by the state (e.g., Maryland) resident at the local retailer 27.

In compliance with state law, the consigned wines never cross over to the host auction state (Delaware) and therefore do not cross back into the buyer's state (Maryland). In this Maryland scenario, the local retailer is assigned a “Key Word” name and the retailer's goods are listed in the URL/Key Word area. The “Key Word” area is specific to each Partner retailer of RAN. The retailer remains the seller of the goods, and the host is the auctioneer. This assignment of the retailer to a Key Word area preserves the legal integrity of auctioning the retailer's wines under the wine license auction of the host. Finally, Maryland state taxes are collected by the host or transferred from the host to the local retailer for payment to the state treasury (e.g., for Maryland) 28.

FIG. 2 demonstrates conformance to the three tier system. Subsequently, there are no state violations pertaining to the interstate shipment of wines.

Other legal factors addressed by the present invention include the following.

No Consignment Restrictions—The wine auction license does not preclude the host from obtaining consignments (transfer or non-transfer) directly from retailers.

No Storage Requirement for Retailer's Wines destined for Local Market—The wine auction license does not require the host to store consigned wines in its warehouse. Therefore, there is no requirement that wines consigned by retailers that are sold over the network (e.g., Internet) to residents of the retailer's state must first be shipped into the host state or that the host must take possession of the retailer's consigned goods.

Warehousing of Goods for Collector's Online and Live Auction—Goods destined for the Collector's Online Auction and Live Auction are transferred to the host's warehouse in the host state. This transfer permits legal transport of consumer goods sold at auction to be shipped to states not prohibiting the import of wine. In addition, this process prevents illegal transport of wine directly from consumer to consumer or from consumers to buyers who are not 21 years of age.

Warehousing of Retailers' Goods Destined for other States or Overseas—Retailers' goods destined for the Collector's Online Auction or Live Auction are transferred to the host's warehouse in the host state. This transfer process permits legal transport of retailer goods sold at auction to be shipped to states not prohibiting the import of wine.

Fee Structure-Revenue Generating Aspect of Model—One revenue generating aspect of the model includes the following features. Retailers join the RAN, pay a monthly membership fee, and pay a commission or network transaction fee respective of their online wine auction sales. In another embodiment, on each of the “Key Word” auction areas of the hundreds of retailers independently hosted, revenues for multiple commercial advertisements are collected.

In summary, the economic bond between the host and the retailer includes sales commissions and/or Internet transaction fees, licensing fees, site maintenance and management fees, and advertising revenues.

Retailer Benefits—The present invention is capable of providing a number of benefits to participants. One benefit for retailers to join RAN is that the network strategy incorporates an online auction format. A second benefit of retailers joining RAN is that they are provided the mechanism of making the transition from “brick and mortar” sales to online auction sales. Third, the RAN model provides national outreach and the capability for retailers to have their goods auctioned to out-of-state consumers. Fourth, RAN expands community outreach and increases in-store sales. Finally, RAN members are enabled to take advantage of the auction host's national marketing efforts.

A compelling reason for retailers to enter into a partnership agreement with the host auction house is that online wine sales are an exceptionally lucrative endeavor. For example, as noted in a recent Salomon Smith Barney report, “online sales of wine in the U.S. will grow from an estimated $75 million last year to between $1.4 billion and $2.9 billion annually in five years.” (Wall Street Journal, Apr. 19, 2000)

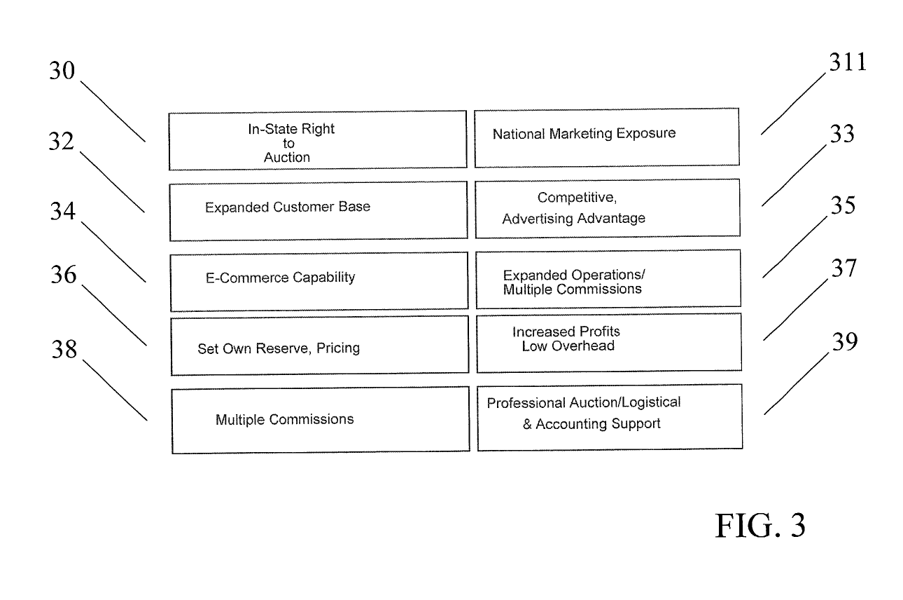

RAN permits wine auction capability at the city, county, state, national and international levels and permits a direct economic relationship with hundreds of retailers and a tangential economic association with tens of thousands of consumers. (The secondary market that RAN targets is the loyal customer of participating retailers). FIG. 3 illustrates benefits to network retailers of various embodiments of the present invention.

E-Commerce Capability—RAN permits legal, in-state, retail business to consumer transactions over the Internet. The RAN program puts retailers in the middle of the 21st Century by providing a modernized method of selling goods. Regardless of whether the retailer does or does not already have their own Web retail site, RAN's innovative approach to utilizing a network, such as the Internet, and promoting goods to a local, national, and international markets meets the retailers' challenges of the new century and places them in a unique and strategic marketing position.

In-State Right to Auction—One underlying marketing premise of the RAN is that partner retailers are provided a competitive advantage within a particular locale that can be transformed into increased revenues.

Expanded Customer Base—An expanded customer base is another RAN outcome that translates into increased revenues for the retailer. RAN provides retailers the opportunity to sell their goods more efficiently to a broader base of buyers. Marketing expenditures for the auction not only increase auction site visitation but visibility (e.g., name recognition) of the store. In addition, customers are likely to be drawn to, for example, the Internet site from areas outside of the retailers' immediate market. Because the Internet has no boundaries, the auction site attracts customers who were previously out of reach.

Set Own Reserve, Pricing—The RAN program permits retailers to determine the auction price range of goods they place for auction, as well as set the reserve. In addition, each RAN participant can determine the number and type of wines they desire to auction without limitation. This is a significantly different procedure from other auction houses, which dictate the terms under which goods are auctioned. One advantage of this approach for retailers is the retaining of control over the appraised value of their goods. Further, retailers may place for auction or pull from auction their goods at any time without fear of violating contract terms set by the more traditional auction house.

Competitive Advertising Advantage—Research presently suggests that the auction, e-commerce model is significantly more effective in selling and attracting customers than the standard retail sales e-commerce model. Importantly, the model permits retailers to sell goods at auction under their own name. Historically, retailer's wines are anonymously sold at auction. While keeping the identity of the seller a secret is appreciated by the individual consignor, anonymity does not lead to the promotional value of name recognition and customer loyalty that is desired by the retailer. RAN's unveiling of the retailers' identity permits this public disclosure to be transformed into a pronounced marketing advantage.

National Marketing Exposure—Use of national marketing efforts in conjunction with the operation of the invention is usable to attract a national audience in search of particular wines to individual auction sites in which that wine may be found. This expanded market for the retailer is exclusive of new, local customers that the RAN might solicit due to local retailer marketing. Certainly, national exposure is another incentive for retailers to join RAN.

Professional Auction/Logistical & Accounting Support—Logistical support, site maintenance and processing of payments are the management responsibility of the host, in accordance with some embodiments of the present invention. These administrative and cost-saving benefits of RAN can only make good sense to the cost conscious retailer participating in the invention.

Increased Profits, Low Overhead—RAN is designed to sell a greater volume of goods at less overhead. More goods sold at less overhead means more profit.

Facilitates In-Store Retail Sales—Persons who buy, for example, at the local retailers' Internet auction site are likely to make further in-store purchases. This is particularly true if delivery of goods outside the County in which the retail store is located is prohibited, and the customer must come to the store to claim their Internet or other network purchases. This occurrence is referred to as the “Boomerang” effect (looping online customers back into the store), a potential online outcome that has significant retail sales implications.

Expanded Operations/Multiple Commissions—RAN essentially offers each retailer another store at a different location. It can be viewed as an inexpensive way to expand operations without the hiring of additional personnel, the need for more floor space, or more rent. For the retailer who has thought about other retail store locations, RAN membership is an ideal way to further penetrate the local market and extend store operations to another jurisdiction at a fraction of the cost of a physical location.

Effect on Competition—In the atmosphere of fervent Internet commerce and the potential ability of the World Wide Web to reach an ever-expanding marketplace, the identification of an assiduous e-commerce and real world marketing strategy is essential to business growth and survival.

The present invention has staggering implications for the competition. The first implication is that the model changes the way auction houses do business with wine retailers. For example, if other auction houses follow this invention, retailers would no longer anonymously consign their wines. Certainly, the removal of anonymity is an attractive selling point for retailers to join RAN. The second implication is that the model offers retailers a new and cost-effective way of conducting business with consumers. RAN extends the retailers' business format from in-store sales to online, wine auction sales. Third, the auction model modifies the retailers advertising methods. In lieu of direct advertisement with a specified price, the auction model is used to promote online sales at a competitive opening bid. Fourth, the model targets the local customer of the retailer, and personal pick-up of the purchased goods is the primary means of transport. This not only precludes violation of interstate shipping laws, but is likely to boost in-store sales. Fifth, the model permits retailers the option of consigning and shipping auction goods to the host for those wines intended for national or International sale. Sixth, the model permits retailers to determine the price (reserve) or price range at which the goods are auctioned. This independence of setting the reserve is particularly attractive because it permits the retailer to self-determine the desired profit margin.

The above factors collectively work to give the pioneers (e-commerce model implementers) of this design the opportunity to reduce the effectiveness of other e-commerce, wine auction models and capture the online wine auction market.

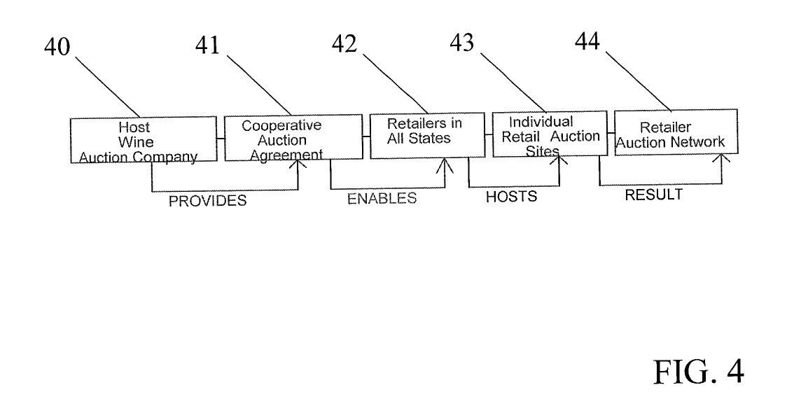

FIG. 4 shows how the host transforms RAN into a viable, e-commerce retail chain, in accordance with an embodiment of the present invention. In the first step of connecting the RAN, cooperative auction agreements 41 are issued from the host 40 to retailers in different states 42, enabling them to participate. In response to the cooperative auction agreement, contracted retailers 42 are hosted by the host 41 and assigned their own location (URL/Key Word) 42 within the host Internet auction site. The result is a chain of participating retailers 43 hosted by the host 40, each a member of RAN.

The RAN e-commerce model has significant utility and is unique for several reasons. First, the model creates a legal, in-state wine auction capability for retailers. Absent the procedures of the RAN, thousands of retailers are prohibited by state law from auctioning wine. This is because most state regulations prohibit alcoholic beverage retailers from holding both a retail and auction license. RAN provides a legal method for retailers to auction wines, and enables them to do so within their own communities. For example, the dynamics of RAN do not violate existing law in Maryland, a state in which retail wine auction licenses are not granted.

Second, Partners of the RAN who are not state licensed to auction wine may list their goods for auction, for example, within a specified URL or “Key Word” area of the host (licensed) wine auction Internet site. In essence, each member retailer is given their own auction site on the RAN/URL, and wines listed and auctioned at the Key Word address are identified as belonging to a specified retailer. This format of listing wines for auction in the name of an unlicensed wine auction retailer, in the absence of RAN, is otherwise prohibited in all states and such network methodology does not elsewhere exist.

Generally speaking, RAN establishes a legitimate vehicle for unlicensed (wine auction) retailers to auction wines to consumers within their own community, as well as to consumers who reside out of state. Importantly, the RAN institutes an e-commerce, wine auction methodology that complies with the states' alcoholic beverage interstate transportation regulations, tax laws and prohibition against selling alcohol to minors.

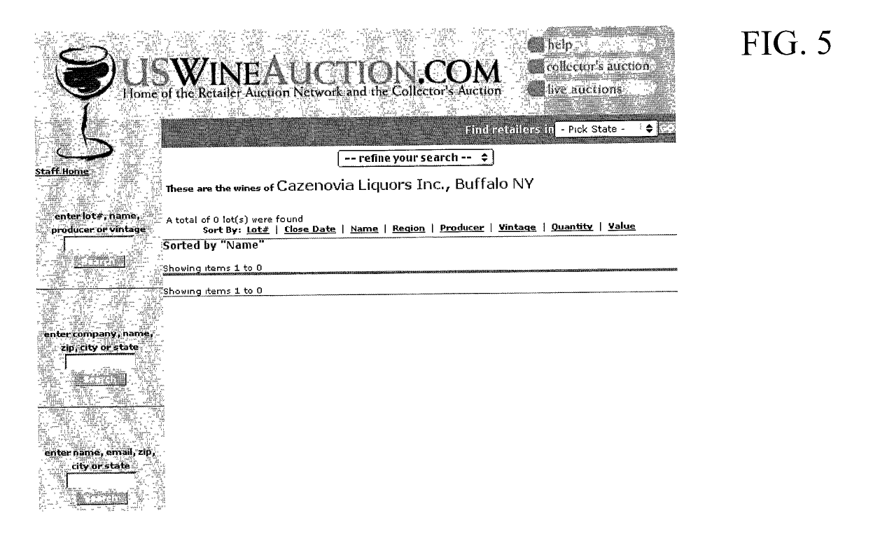

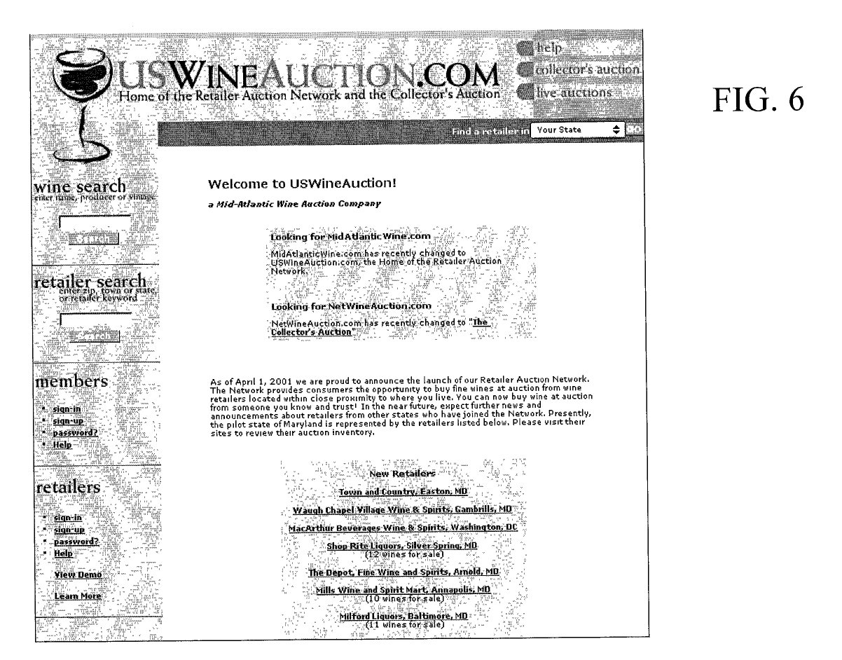

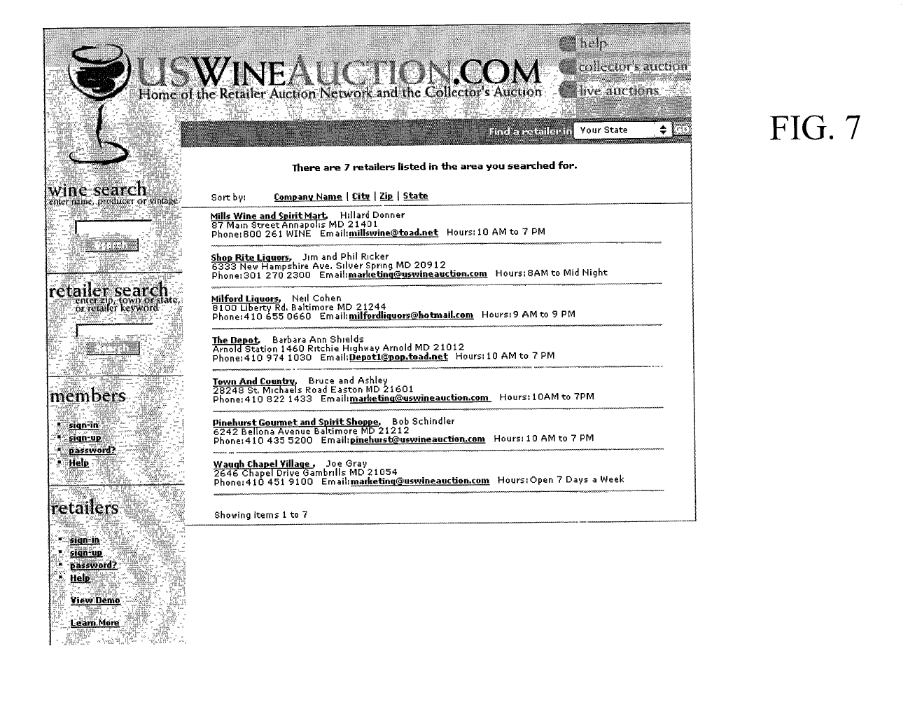

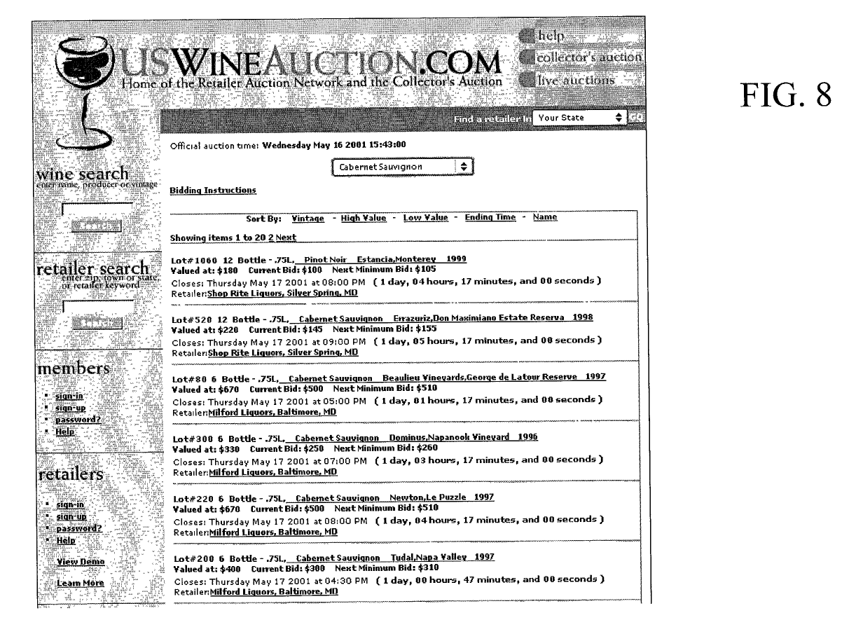

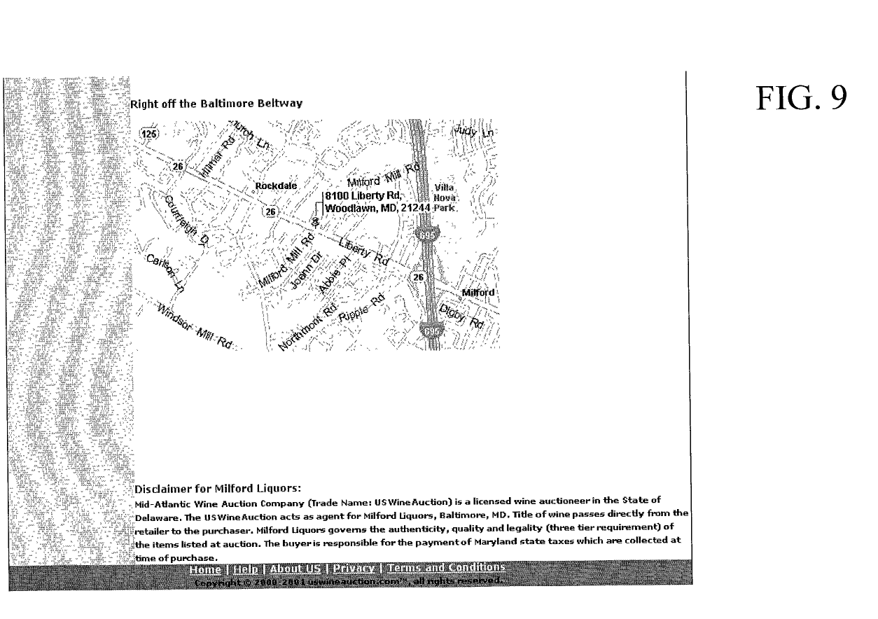

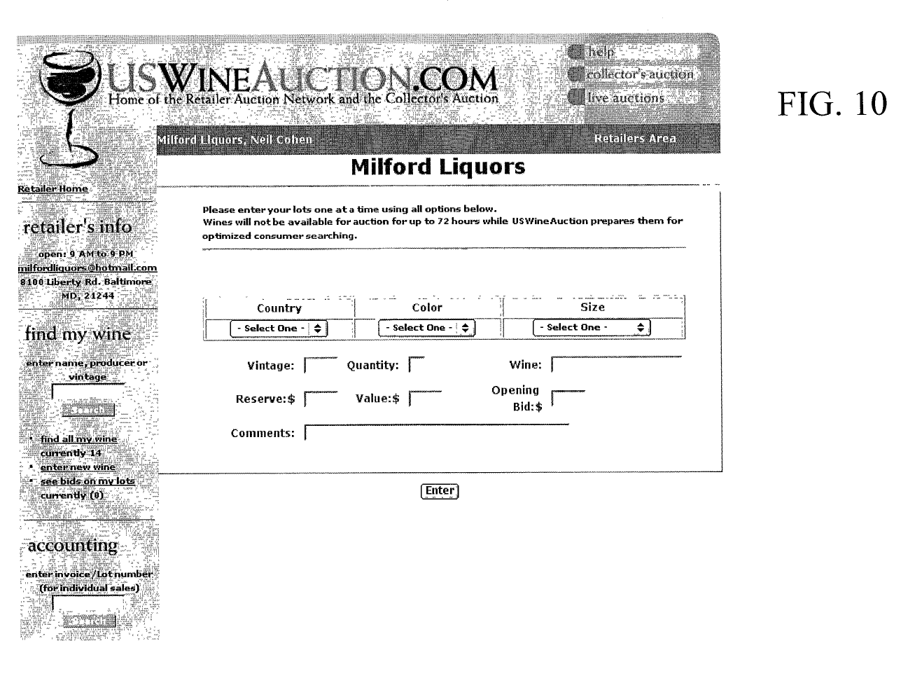

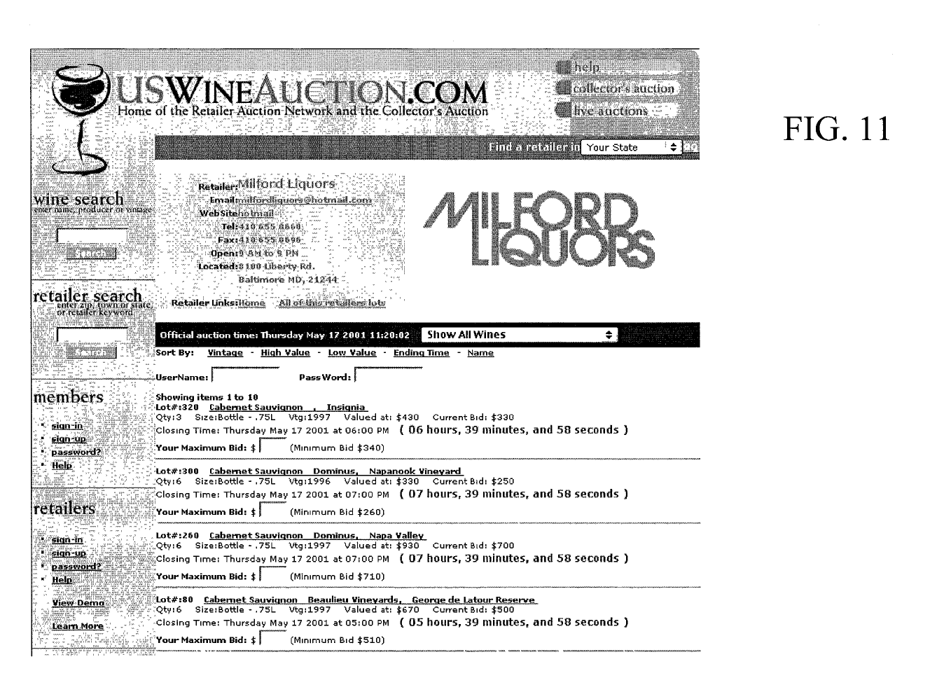

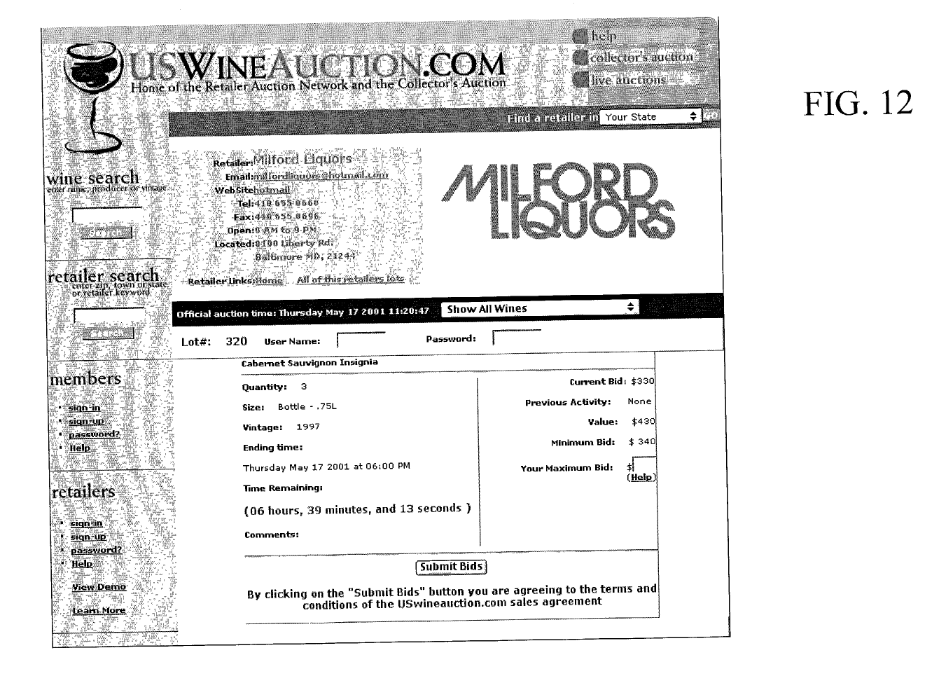

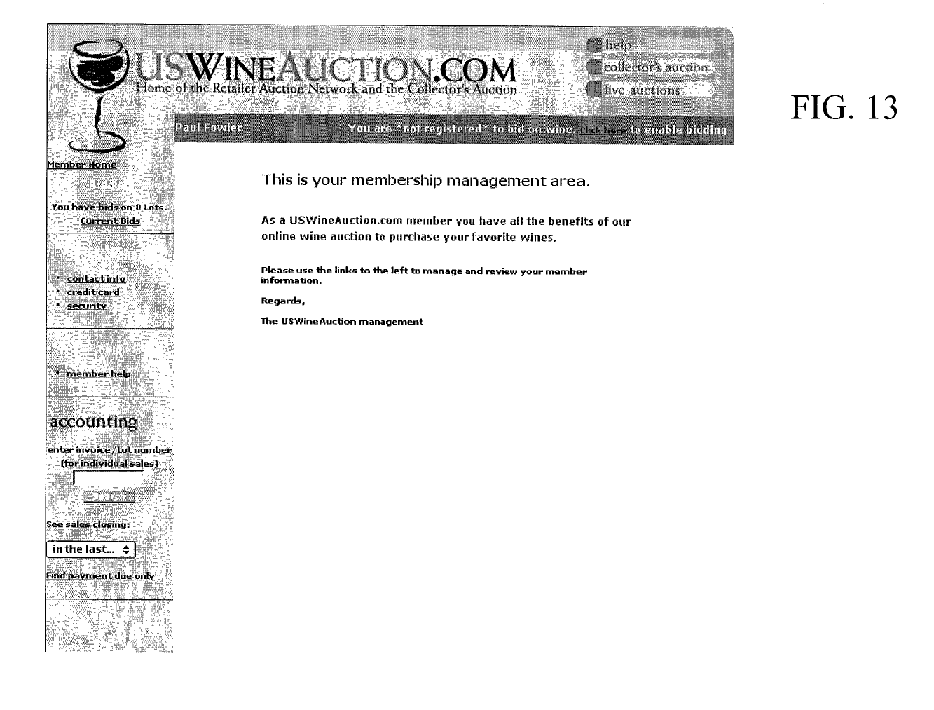

FIGS. 5-13 present sample GUI screens for a network-based system, such as Internet-based system, for use in accordance with an embodiment of the present invention.

Thus, while there have been shown, described, and pointed out fundamental novel features of the invention as applied to embodiments thereof, it will be understood that various omissions, substitutions, and changes in the form and the details of the disclosed invention may be made by those skilled in the art without departing from the spirit of the invention.

What is claimed is:

1. A method for auctioning, to a purchaser, wines from a local retailer using a host auction company via a network, the method comprising:
the local retailer consigning the wines to the host auction company;
the host auction company auctioning the wines;
the purchaser purchasing the wines; and
the purchaser obtaining the purchased wines directly from the local retailer.

2. The method of claim 1, wherein consigning the wines includes transferring the wines.

3. The method of claim 1, further comprising:
the host auction company presenting the wines in technological auction format.

4. The method of claim 1, wherein the network is the Internet.

5. The method of claim 1, wherein the wines are auctioned via a network site.

6. The method of claim 5, wherein the network site is an Internet site.

7. The method of claim 6, wherein the Internet site has a uniform resource locator.

8. The method of claim 7, wherein the local retailer is assigned their own uniform resource locator.

9. The method of claim 7, wherein the local retailer is assigned a key word name.

10. The method of claim 9, wherein the key word name of the local retailer is searchable from within the Internet site.

11. The method of claim 9, wherein the key word name of the local retailer is accessible via the Internet site.

12. The method of claim 1, wherein the local retailer is located in a state, and wherein the purchaser is a resident of the local retailer state.

13. The method of claim 12, wherein the state has a state wine tax, the method further comprising:
collecting the state wine tax.

14. The method of claim 13, wherein the local retailer collects the state wine tax.

15. The method of claim 13, wherein the host auction company collects the state wine tax.

16. The method of claim 13, wherein the host auction company transfers the state wine tax to the local retailer.

17. The method of claim 13, wherein the local retailer pays the state wine tax to the state treasury.

18. The method of claim 12, wherein the wine remains in the state.

19. The method of claim 1, wherein the wine is transferred to the warehouse of the host auction company.

20. The method of claim 19, wherein the wine is delivered to the purchaser of the wine from the warehouse of the host auction company.

21. The method of claim 1, wherein the purchaser obtains the purchased wines from the host auction company acting on behalf of the local retailer.

22. The method of claim 21, wherein the local retailer is located in a local retailer state, wherein the host auction company obtains authorization from the local retailer state to act as agent for the local retailer in the local retailer state.

23. The method of claim 21, wherein the host auction company processes payment transactions and collects taxes for the local retailer.

24. The method of claim 1, wherein the purchaser purchases wines from the local retailer in conjunction with the host auction company acting as licensed agent of the local retailer.

25. The method of claim 1, wherein the purchaser purchases wines from the local retailer.

26. The method of claim 24, wherein the host auction company has a wine auction license, and wherein the local retailer has a wine auction license that operates in conjunction with the host auction company's wine auction license.

27. The method of claim 24, wherein the host auction company collects sales payments for the local retailer.

28. The method of claim 24, wherein the retailer collects sales payments for the purchased wines.

29. The method of claim 1, wherein the host company uses a third party online company to display wines in auction format.

30. The method of claim 1, wherein the host company uses a third party online company to act as auction medium for the host auction company.

31. A method for auctioning, to a purchaser, wines from a local retailer using a host auction company via a network, the method comprising:
the local retailer consigning the wines to the host auction company;
the host auction company auctioning the wines;
the purchaser purchasing the wines; and
the purchaser obtaining the purchased wines from the host auction company acting on behalf of the local retailer.

32. A method for auctioning, to a purchaser, wines from a local retailer using a host auction company via a network, the method comprising:
the local retailer consigning the wines to the host auction company;
the host auction company auctioning the wines; and
the purchaser purchasing wines from the local retailer in conjunction with the host auction company acting as licensed agent of the local retailer.

33. A method for auctioning, to a purchaser, wines from a local retailer using a host auction company via a network, the method comprising:
the local retailer consigning the wines to the host auction company;
the host auction company auctioning the wines;
the purchaser purchasing wines from the licensed wine auction retailer in conjunction with the host auctioneer acting as licensed agent of the local retailer;
the host auction company using a third party online company to display wines in auction format; and
the third party online company to act as an auction medium of the host auction company.

34. A system for auctioning, to a purchaser, wines from a local retailer using a host auction company via a network, comprising:
at least one terminal coupled to the network; and
a server for the host auction company coupled to the network;
wherein the local retailer consigns the wines to the host auction company;
wherein the host auction company auctions the wines via the at least one server and via the network;
wherein the purchaser purchases the wines via the at least one terminal via the network; and
wherein the purchaser obtains the purchased wines from the local retailer.

35. The system of claim 34, wherein the local retailer is located in a state, the system further comprising:
an alternative server located in the state of the local retailer;

36. The system of claim 35, wherein the local retailer optionally auctions the wines via the alternative server in the state of the local retailer and via the network.

37. The system of claim 34, wherein the local retailer transfers the wines to the host auction company.

38. The system of claim 34, wherein the at least a first terminal is coupled to the network via a coupling.

39. The system of claim 38, wherein the coupling comprises one from a group consisting of a wired connection, a wireless connection, and a fiberoptic connection.

40. The system of claim 34, wherein the at least a first terminal comprises one selected from a group consisting of a personal computer, a minicomputer, a microcomputer, a main frame computer, a telephone device, and a television.

41. The system of claim 34, wherein the at least one server comprises one selected from a group consisting of a personal computer, a minicomputer, a microcomputer, and a main frame computer.

42. The system of claim 34, wherein the at least one server comprises a storage device, the storage device including an accessible repository.

43. The system of claim 34, further comprising:
a repository server coupled to the at least one server, the repository server comprising a storage device, wherein the storage device includes an accessible repository.
